(19) United States
(12) Patent Application Publication
(10) Pub. No.: US 2022/0154037 A1
(43) Pub. Date: May 19, 2022

(54) POLYASPARTIC COATINGS WITH RECOAT AND STABLE INITIAL GLOSS

(71) Applicant: Covestro LLC, Pittsburgh, PA (US)

(72) Inventors: Charles Todd Williams, Lakewood, CO (US); Joseph Kleer, Crescent, PA (US); Ahren Olson, Aliquippa, PA (US); Daniel P. Wang, Pittsburgh, PA (US)

(21) Appl. No.: 16/952,519

(22) Filed: Nov. 19, 2020

(51) Int. Cl. C09D 175/12; C08K 5/521; C08G 18/73; C08G 18/64

(52) U.S. Cl. CPC C09D 175/12; C08K 5/521; C08G 2150/00; C08G 18/6415; C08G 18/73

(57) ABSTRACT

Provided is a polyaspartic composition comprising a reaction product of a polyamine with a Michael addition receptor, a pigment, and from >0% to ≤3% of a phosphoric acid ester dispersant, wherein the percentage is calculated as (weight of dispersant solids/weight of pigment solids)×100. The inventive polyaspartic compositions may be reacted with a polyisocyanate to provide coatings, adhesives, sealants, composites, castings, and films having a stable initial gloss. Also provided is a method of increasing 60° gloss in a cured polyurea or polyurethane composition, the method comprising reacting a polyisocyanate with the inventive polyaspartic composition to form a reaction product and curing the reaction product, wherein 60° gloss of the cured polyurea or polyurethane composition is ≥80%. The high 60° gloss is maintained over at least one-week, and in some cases over at least four weeks, at 40° C. and 80% relative humidity.

### FIELD OF THE INVENTION

The present invention relates in general to coatings, and more specifically to polyurea or polyurethane coatings made from polyaspartic compositions containing a phosphoric acid ester dispersant.

### BACKGROUND OF THE INVENTION

One of the problems inherent in high gloss polyaspartic, pigmented coatings is that there is a tendency to lose gloss in high temperature/high humidity conditions. This tendency can result in gloss reduction in the first 24-48 hours which reduces the gloss level to the semi-gloss region.

To reduce these problems therefore, a need exists in the art for a polyaspartic composition which will reduce 60° gloss loss in high temperature/high humidity conditions.

### SUMMARY OF THE INVENTION

Accordingly, the present invention reduces or eliminates problems inherent in the art by providing a polyaspartic composition comprising a reaction product of a polyamine with a Michael addition receptor, and >0% to ≤3% of a phosphoric acid ester dispersant, wherein the % is calculated as (weight of dispersant solids/weight of pigment solids)×100. The inventive polyaspartic composition may be reacted with a polyisocyanate to provide a high initial gloss in a polyurea composition, wherein gloss is ≥80%. This high gloss is maintained over at least a one-week period at high temperature (≥40° C.) and high humidity (≥80% relative humidity) conditions. These and other advantages and benefits of the present invention will be apparent from the Detailed Description of the Invention herein below.

### BRIEF DESCRIPTION OF THE FIGURES

The present invention will now be described for purposes of illustration and not limitation in conjunction with the figures, wherein:

FIG. 1 shows initial 60° gloss in a constant temperature room (CTR) at 21.1° C. and 50% relative humidity;

FIG. 2 illustrates initial 60° gloss in THERMOTRON environmental test chamber at 40° C. and 80% relative humidity;

FIG. 3 shows four week 60° gloss in a constant temperature room (CTR) at 21.1° C. and 50% relative humidity;

FIG. 4 illustrates four week 60° gloss in THERMOTRON environmental test chamber at 40° C. and 80% relative humidity;

FIG. 5 compares the IR spectra (absorbance vs. wavenumber) of hydantoin formation at one day, with no acid, 0.125% acid, 0.25% acid, and 0.5% acid;

FIG. 6 provides a comparison of the IR spectra (absorbance vs. wavenumber) of hydantoin formation with no acid at one hour, at one week, and at one day;

FIG. 7 illustrates a comparison of the IR spectra (absorbance vs. wavenumber) of hydantoin formation with 0.125% acid at one hour, at one week, and at one day;

FIG. 8 shows a comparison of the IR spectra (absorbance vs. wavenumber) of hydantoin formation with 0.25% acid at one hour, at one week, and at one day;

FIG. 9 provides the IR spectra (absorbance vs. wavenumber) of a hydantoin acid ladder study with no acid added;

FIG. 10 illustrates the IR spectra (absorbance vs. wavenumber) of a hydantoin acid ladder study with 0.125% acid added; and

FIG. 11 shows the IR spectra (absorbance vs. wavenumber) of a hydantoin acid ladder study with 0.25% acid added.

### DETAILED DESCRIPTION OF THE INVENTION

The present invention will now be described for purposes of illustration and not limitation. Except in the operating examples, or where otherwise indicated, all numbers expressing quantities, percentages, and so forth in the specification are to be understood as being modified in all instances by the term “about.”

Any numerical range recited in this specification is intended to include all sub-ranges of the same numerical precision subsumed within the recited range. For example, a range of “1.0 to 10.0” is intended to include all sub-ranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited in this specification is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such sub-ranges would comply with the requirements of 35 U.S.C. § 112(a), and 35 U.S.C. § 132(a). The various embodiments disclosed and described in this specification can comprise, consist of, or consist essentially of the features and characteristics as variously described herein.

Any patent, publication, or other disclosure material identified herein is incorporated by reference into this specification in its entirety unless otherwise indicated, but only to the extent that the incorporated material does not conflict with existing definitions, statements, or other disclosure material expressly set forth in this specification. As such, and to the extent necessary, the express disclosure as set forth in this specification supersedes any conflicting material incorporated by reference herein. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicant reserves the right to amend this specification to expressly recite any subject matter, or portion thereof, incorporated by reference herein.

Reference throughout this specification to “various non-limiting embodiments,” “certain embodiments,” or the like, means that a particular feature or characteristic may be included in an embodiment. Thus, use of the phrase “in various non-limiting embodiments,” “in certain embodiments,” or the like, in this specification does not necessarily refer to a common embodiment, and may refer to different embodiments. Further, the particular features or characteristics may be combined in any suitable manner in one or more embodiments. Thus, the particular features or characteristics illustrated or described in connection with various or certain embodiments may be combined, in whole or in part, with the features or characteristics of one or more other embodiments without limitation. Such modifications and variations are intended to be included within the scope of the present specification.

The grammatical articles “a”, “an”, and “the”, as used herein, are intended to include “at least one” or “one or more”, unless otherwise indicated, even if “at least one” or “one or more” is expressly used in certain instances. Thus, these articles are used in this specification to refer to one or more than one (i.e., to “at least one”) of the grammatical objects of the article. By way of example, and without limitation, “a component” means one or more components, and thus, possibly, more than one component is contemplated and may be employed or used in an implementation of the described embodiments. Further, the use of a singular noun includes the plural, and the use of a plural noun includes the singular, unless the context of the usage requires otherwise.

In a first aspect, the invention is directed to a polyaspartic composition comprising a reaction product of a polyamine with a Michael addition receptor, a pigment, and from >0% to ≤3% of a phosphoric acid ester dispersant, wherein the percentage is calculated as (weight of dispersant solids/weight of pigment solids)×100.

In a second aspect, the invention is directed to a polyurea or polyurethane composition comprising a reaction product of a polyisocyanate and the polyaspartic composition according to the previous paragraph.

In a third aspect, the invention is directed to a method of increasing 60° gloss in a cured polyurea or polyurethane composition, the method comprising reacting a polyisocyanate with a polyaspartic composition according to the first aspect; and curing the polyurea composition, wherein 60° gloss of the cured polyurea or polyurethane composition is ≥80%. The high 60° gloss is maintained over at least one-week, and in some cases over at least four weeks, at 40° C. and 80% relative humidity.

As used herein, the term “polymer” encompasses prepolymers, oligomers and both homopolymers and copolymers; the prefix “poly” in this context referring to two or more. As used herein, the term “molecular weight”, when used in reference to a polymer, refers to the number average molecular weight, unless otherwise specified.

As used herein, the term “coating composition” refers to a mixture of chemical components that will cure and form a coating when applied to a substrate.

“Cured”, “cured composition” or “cured compound” refers to components and mixtures obtained from reactive curable original compound(s) or mixture(s) thereof which have undergone chemical and/or physical changes such that the original compound(s) or mixture(s) is(are) transformed into a solid, substantially non-flowing material. A typical curing process may involve crosslinking.

The term “curable” means that an original compound(s) or composition material(s) can be transformed into a solid, substantially non-flowing material by means of chemical reaction, crosslinking, radiation crosslinking, or the like. Thus, compositions of the invention are curable, but unless otherwise specified, the original compound(s) or composition material(s) is(are) not cured.

As used herein, the term “pot life” refers to the period of time from the initial mixture of two or more mutually reactive components of a coating system to the point at which the resulting coating composition exhibits a workable viscosity.

As used herein, the term “cure time” refers to the time to achieve Stage D (Method B) as defined in ASTM D5895-03 (2008)—Standard Test Methods for Evaluating Drying or Curing During Film Formation of Organic Coatings Using Mechanical Recorder.

As used herein, the term “polyurethane” refers to polymeric or oligomeric materials comprising urethane groups, urea groups, or both. Accordingly, as used herein, the term “polyurethane” is synonymous with the terms polyurea, polyurethane/urea, and modifications thereof. The term “polyurethane” also refers to crosslinked polymer networks in which the crosslinks comprise urethane and/or urea linkages, and/or the constituent polymer chains comprise urethane and/or urea linkages. Carbodiimide crosslinking as is known to those skilled in the art is also contemplated in the coatings of the invention.

The coating compositions described in this Specification may comprise a two-component coating composition. As used herein, the term “two-component” refers to a coating or coating composition comprising at least two components that must be stored in separate containers because of their mutual reactivity. For instance, two-component polyurea coating systems and compositions may comprise a hardener/crosslinker component comprising an isocyanate-functional compound, and a separate binder component comprising an amino-functional compound. The two separate components are generally not mixed until shortly before application because of the limited pot life of the mixture. When the two separate components are mixed and applied as a film on a substrate, the mutually reactive compounds in the two components react to crosslink and form a cured coating film.

As used herein, the term “polyamine” refers to compounds comprising at least two free primary and/or secondary amine groups. Polyamines include polymers comprising at least two pendant and/or terminal amine groups.

As used herein, the term “polyisocyanate” refers to compounds comprising at least two un-reacted isocyanate groups. Polyisocyanates include diisocyanates and diisocyanate reaction products comprising, for example, biuret, isocyanurate, uretdione, urethane, urea, iminooxadiazine dione, oxadiazine dione, carbodiimide, acyl urea, allophanate groups, and combinations of any thereof.

The polyisocyanate useful in the present invention may comprise any organic polyisocyanate having aliphatically, cycloaliphatically, araliphatically, and/or aromatically bound free isocyanate groups, which are liquid at room temperature or are dispersed in a solvent or solvent mixture at room temperature. In various non-limiting embodiments, the polyisocyanate may have a viscosity of from 10-15,000 mPa s at 23° C., 10-5,000 mPa s at 23° C., or 50-1,000 mPa s at 23° C. In certain embodiments, the polyisocyanate may comprise polyisocyanates or polyisocyanate mixtures having exclusively aliphatically and/or cycloaliphatically bound isocyanate groups with an (average) NCO functionality of 2.0-5.0 and a viscosity of from 10-5,000 mPa s at 23° C., 50-1,000 mPa s at 23° C., or 100-1,000 mPa s at 23° C.

In various embodiments, the polyisocyanate may comprise polyisocyanates or polyisocyanate mixtures based on one or more aliphatic or cycloaliphatic diisocyanates, such as, for example, ethylene diisocyanate; 1,4-tetramethylene diisocyanate; 1,6-hexamethylene diisocyanate (HDI); 2,2,4-trimethyl-1,6-hexamethylene diisocyanate; 1,12-dodecamethylene diisocyanate; 5-isocyanato-1-(isocyanatomethyl)-1,3,3-trimethylcyclohexane (IPDI); bis-(4-isocyanatocyclohexyl)methane (H₁₂MDI); cyclohexane 1,4-diisocyanate; bis-(4-isocyanato-3-methyl-cyclohexyl)methane; pentane diisocyanate (PDI), isomers of any thereof; or combinations of any thereof. In various embodiments, the polyisocyanate component may comprise polyisocyanates or polyisocyanate mixtures based on one or more aromatic diisocyanates, such as, for example, benzene diisocyanate; toluene diisocyanate (TDI); diphenylmethane diisocyanate (MDI); isomers of any thereof; or combinations of any thereof. In various embodiments, the polyisocyanate component may comprise a triisocyanate, such as, for example, 4-isocyanatomethyl-1,8-octane diisocyanate (triisocyanatononane or TIN); isomers thereof; or derivatives thereof.

Additional polyisocyanates (including various diisocyanates) that may also be included in the polyurea compositions of the present invention may include those described in U.S. Pat. Nos. 5,075,370; 5,304,400; 5,252,696; 5,750,613; and 7,205,356. Combinations of any of the above-identified polyisocyanates may also be used.

The di- and tri-isocyanates indicated may be used as such, or as derivative polyisocyanates comprising biuret, isocyanurate, uretdione, urethane, urea, iminooxadiazine dione, oxadiazine trione, carbodiimide, acyl urea, and/or allophanate groups. In various non-limiting embodiments, derivative polyisocyanates comprising biuret, isocyanurate, uretdione, urethane, iminooxadiazine dione, oxadiazine trione, carbodiimide, acyl urea, and/or allophanate groups are included in the polyurea. In various embodiments, the polyisocyanate component comprises one or more of the above-identified structural groups prepared from IPDI, HDI, H₁₂MDI, and/or cyclohexane 1,4-diisocyanate.

The polyisocyanate may be hydrophilically-modified to be water-dispersible. Hydrophilically-modified water-dispersible polyisocyanates are obtainable, for example, by covalent modification with an internal emulsifier comprising anionic, cationic, or nonionic groups.

Polyether urethane type water-dispersible polyisocyanates may be formed, for example, from a reaction between polyisocyanates and less than stoichiometric amounts of monohydric polyalkylene oxide polyether alcohols. The preparation of such hydrophilically-modified polyisocyanates is described, for example, in U.S. Pat. No. 5,252,696. Polyether allophanate type water-dispersible polyisocyanates may be formed, for example, from a reaction between a polyalkylene oxide polyether alcohol and two polyisocyanate molecules under allophanation conditions. The preparation of such hydrophilically-modified polyisocyanates is described, for example, in U.S. Pat. No. 6,426,414. The polyalkylene oxide polyether alcohol used to prepare polyether type hydrophilically-modified water-dispersible polyisocyanates may comprise, for example, polyethylene oxide residues and/or polypropylene oxide residues.

Polyisocyanates may also be covalently modified with ionic or potentially ionic internal emulsifying groups to form hydrophilically-modified water-dispersible polyisocyanates. The ionic or potentially ionic groups may be cationic or anionic. As used herein, the term “ionic or potentially ionic group” refers to a chemical group that is nonionic under certain conditions and ionic under certain other conditions. For example, in various embodiments, the ionic group or potentially ionic group may comprise a carboxylic acid group; a carboxylate group; a sulfonic acid group; a sulfonate group; a phosphonic acid group; a phosphonate group; or combinations of any thereof. In this regard, for example, carboxylic acid groups, sulfonic acid groups, and phosphonic acid groups are potentially ionic groups, whereas, carboxylate groups, sulfonate groups, and phosphonate groups are ionic groups in the form of a salt, such as, for example, a sodium salt.

For example, carboxylate (carboxylic acid) groups, sulfonate (sulfonic acid) groups, or phosphonate (phosphonic acid) groups may be covalently introduced into polyisocyanates to form hydrophilically-modified water-dispersible polyisocyanates. The ionic or potentially ionic groups may be introduced through a reaction between the isocyanate groups of the polyisocyanate and less than stoichiometric amounts of amino-functional or hydroxy-functional carboxylic acids, sulfonic acids, phosphonic acids, or salts thereof. Examples include, but are not limited to dimethylolpropionic acid (DMPA), N-(2-aminoethyl)-2-aminoethane sulfonic acid (AAS); N-(2-aminoethyl)-2-aminopropionic acid; 2-(cyclohexyl-amino)-ethane sulfonic acid; 3-(cyclohexyl-amino)-1-propane sulfonic acid (CAPS); 2-aminoethylphosphonic acid; or the salts thereof.

If free carboxylic acids, sulfonic acids, or phosphonic acids are incorporated in the polyisocyanate, then the acids may be neutralized with a neutralizing agent, such as, for example, tertiary amines, including, but not limited to, trialkyl-substituted tertiary amines. The preparation of hydrophilically-modified water-dispersible polyisocyanates is described, for example, in U.S. Pat. No. 6,767,958. Water-dispersible polyisocyanate mixtures based on triisocyanatononane (TIN) are described in International Patent Application Publication No. WO01/62819.

The NCO content of nonionic type hydrophilically-modified water-dispersible polyisocyanates may be from 5 to 25 weight percent of the polyisocyanate molecule. The NCO content of ionic type hydrophilically-modified water-dispersible polyisocyanates may be from 4 to 26 weight percent of the polyisocyanate molecule.

As those skilled in the art are aware, a polyaspartic ester may be produced by reacting a polyamine with a Michael addition receptor, i.e., an electron withdrawing group such as cyano, keto or ester (an electrophile) in a Michael addition reaction. Examples of suitable Michael addition receptors include, but are not limited to, acrylates and diesters such as dimethyl maleate, diethyl maleate, dibutyl maleate, dimethyl fumarate, diethyl fumarate, and dibutyl fumarate.

The polyaspartic composition may include one or more polyaspartic esters corresponding to formula (I):

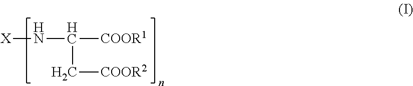

wherein:
n is an integer of 2 to 4
X represents an aliphatic residue;
R¹ and R² independently of each other represent organic groups that are inert to isocyanate groups under reaction conditions; and
n is at least 2.

In formula (I), the aliphatic residue X may correspond to a straight or branched alkyl and/or cycloalkyl residue of an n-valent polyamine that is reacted with a dialkylmaleate in a Michael addition reaction to produce a polyaspartic ester. For example, the residue X may correspond to an aliphatic residue from an n-valent polyamine including, but not limited to, ethylene diamine; 1,2-diaminopropane; 1,4-diaminobutane; 1,6-diaminohexane; 2,5-diamino-2,5-dimethylhexane; 2,2,4- and/or 2,4,4-trimethyl-1,6-diaminohexane; 1,11-diaminoundecane; 1,12-diaminododecane; 1-amino-3,3,5-trimethyl-5-amino-methylcyclohexane; 2,4′- and/or 4,4′-diaminodicyclohexylmethane; 3,3′-dimethyl-4,4′-diaminodicyclohexylmethane; 2,4,4′-triamino-5-methyldicyclohexylmethane; polyether polyamines with aliphatically bound primary amino groups and having a number average molecular weight (Mₙ) of 148 to 6000 g/mol; isomers of any thereof, and combinations of any thereof.

In various embodiments, the residue X may be obtained from 1,4-diaminobutane; 1,6-diaminohexane; 2,2,4- and/or 2,4,4-trimethyl-1,6-diaminohexane; 1-amino-3,3,5-trimethyl-5-aminomethylcyclohexane; 4,4′-diaminodicyclohexylmethane; 3,3′-dimethyl-4,4′-diaminodicyclohexylmethane; or 1,5-diamine-2-methyl-pentane.

The phrase “inert to isocyanate groups under reaction conditions”, which is used to define groups R¹ and R² in formula (I), means that these groups do not have Zerevitinov-active hydrogens. Zerevitinov-active hydrogen is defined in Rompp's Chemical Dictionary (Rommp Chemie Lexikon), 10^{th} ed., Georg Thieme Verlag Stuttgart, 1996. Generally, groups with Zerevitinov-active hydrogen are understood in the art to mean hydroxyl (OH), amino (NHₓ), and thiol (SH) groups. In various embodiments, R¹ and R², independently of one another, are C₁ to C₁₀ alkyl residues, such as, for example, methyl, ethyl, or butyl residues.

In various embodiments, the polyaspartic composition comprises one or more compounds corresponding to formula (I) in which n is an integer from 2 to 6, in some embodiments from 2 to 4, and in some embodiments 2. In embodiments, where n=2, the polyaspartic composition may comprise one or more compounds corresponding to formula (II):

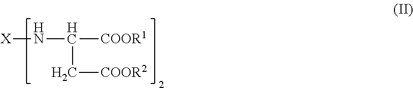

The polyaspartic composition may be produced by reacting the corresponding primary polyamines of the formula:

X [symbol] NH₂]ₙ

with a diester of the formula:

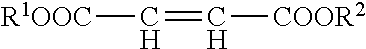

The production of the inventive polyaspartic composition from the above-mentioned polyamine and Michael addition receptor starting materials may take place within a temperature range of 0° C. to 100° C., in certain embodiments, the temperature is no greater than 45° C.

Phosphoric acid ester dispersants are typically included in resin formulations as emulsifiers and dispersants for pigments and fillers. Such dispersants are described in numerous patents including U.S. Pat. No. 5,130,463 which discloses compounds having the following formula:

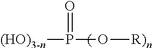

wherein R is an aliphatic, cycloaliphatic and/or aromatic moiety free of Zerewitinoff hydrogen, containing at least one ether oxygen atom (—O—) and at least one carboxylic acid ester group (—COO—) and/or urethane group (—NHCOO—), and having an average molecular weight M of 200 to 10,000, in which the hydrogen atoms of the aliphatic groups may be partially replaced by halogen atoms, and wherein the ratio of the number of ether oxygen atoms to the number of the carboxylic acid ester groups and/or urethane groups in each group R is in the range from 1:20 to 20:1, and n is 1 or 2. Other patents and publications describing suitable phosphoric acid ester dispersants for use in the invention include U.S. Pat. Nos. 6,423,130; 6,689,731; and U.S. Pat. Pub. No. 2015/0038641. Phosphoric acid ester dispersants are available under such names as DISPERBYK-110 DISPERBYK-111 DISPERBYK-180.

The present inventors have surprisingly found that inclusion of phosphoric acid ester dispersants in amounts of from >0% to ≤3% of a phosphoric acid ester dispersant can improve gloss retention over time. Thus, in various embodiments, the phosphoric acid ester dispersants are included in amounts of from >0% to ≤3% of a phosphoric acid ester dispersant, in certain embodiments in amounts of 0.125% to 2%, and in selected embodiments in amounts of 0.75% to 1.5%, and in very selected embodiments in amounts of 1.0% to 1.5%, wherein the percentage is calculated as (weight of dispersant solids/weight of pigment solids)×100.

A variety of pigments can be included in the inventive compositions. Suitable pigments can include organic pigments, inorganic pigments, natural pigments, synthetic pigments, or a combination thereof. Non-limiting examples can include a black pigment, a blue pigment, a brown pigment, a gold pigment, a green pigment, a grey pigment, an orange pigment, a pink pigment, a red pigment, a violet pigment, a white pigment, a yellow pigment, the like, or a combination thereof.

Non-limiting examples of black pigments can include carbon black, ivory black, vine black, lamp black, mars black, titanium black, manganese dioxide, the like, or a combination thereof. Non-limiting examples of blue pigments can include ultramarine blue, Persian blue, cobalt blue, cerulean blue, Egyptian blue, han blue, azurite, Prussian blue, YInMn blue, manganese blue, phthalocyanine blue, the like, or a combination thereof. Non-limiting examples of brown pigments can include raw umber, raw sienna, the like, or a combination thereof. Non-limiting examples of gold pigments can include bronze powder, copper alloy, metallic gold, the like or a combination thereof. Non-limiting examples of green pigments can include cadmium green, chrome green, viridian, cobalt green, malachite, Scheele's green, green earth, the like, or a combination thereof. Non-limiting examples of grey pigments can include bismuth powder, iron powder, metallic silver, stainless steel powder, aluminum powder, metallic lead, pewter, metallic zinc, the like, or a combination thereof. Non-limiting examples of orange pigments can include cadmium orange, chrome orange, the like or a combination thereof. Non-limiting examples of pink pigments can include coral pink, pearl pink, pink mica, purpurite, the like, or a combination thereof. Non-limiting examples of red pigments can include realgar, cadmium red, sanguine, caput mortuum, indian red, venetian red, oxide red, red ochre, burnt sienna, minium, vermilion, quinacridone, the like, or a combination thereof. Non-limiting examples of violet pigments can include ultramarine violet, han purple, phthalo blue, cobalt violet, manganese violet, purple of cassius, the like, or a combination thereof. Non-limiting examples of white pigments can include antimony white, barium sulfate, lithopone, cremnitz white, titanium white, zinc white, the like, or a combination thereof. Non-limiting examples of yellow pigments can include orpiment, primrose yellow, cadmium yellow, chrome yellow, potassium cobaltinitrite (Cobalt yellow), yellow ochre, Naples yellow, lead-tin-yellow, titanium yellow, mosaic gold, zinc yellow, the like, or a combination thereof.

Conventional aspartates are capable of a further transformation (after curing with an isocyanate) to form a thermodynamically favored hydantoin ring structure. As those skilled in the art are aware, hydantoin formation may lead to a shrinking of the coating and undesired alcohol formation as illustrated below.

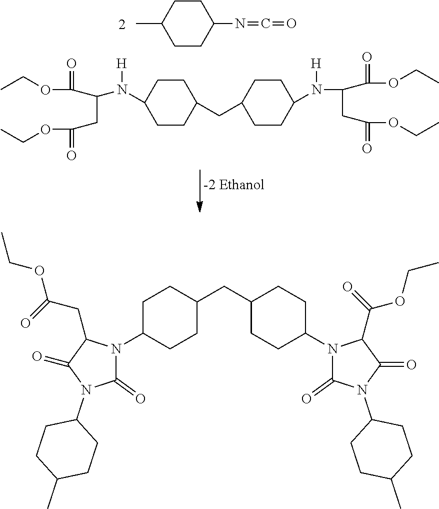

As mentioned herein, the inventive polyaspartic compositions may be combined with a polyisocyanate to produce polyurea or polyurethane compositions. The inventive polyurea or polyurethane compositions may be applied to a substrate in the form of a coating composition by conventional methods such as painting, rolling, pouring or spraying. Suitable substrates include, but are not limited to, metals, plastics, wood, cement, concrete and glass. The substrates to be coated by the polyurea or polyurethane coating composition according to the invention optionally may be treated with suitable primers.

The inventive coatings optionally may contain further additives such as fillers, softeners, high-boiling liquids, catalysts, UV stabilizers, anti-oxidants, microbiocides, algicides, dehydrators, thixotropic agents, wetting agents, flow enhancers, matting agents, anti-slip agents, aerators, and extenders.

Although the present invention is described and exemplified in the instant Specification in the context of a polyurea coating composition, the invention is not intended to be so limited. The principles of the invention are equally applicable to polyurethane, polyurea, polyurethane/urea coatings, adhesives, sealants, composites, castings, and films.

### Examples

The non-limiting and non-exhaustive examples that follow are intended to further describe various non-limiting and non-exhaustive embodiments without restricting the scope of the embodiments described in this specification. All quantities given in “parts” and “percents” are understood to be by weight, unless otherwise indicated.

| | |
|---|---|
| ASPARTATE A | a 100% solids content aspartic ester functional amine, |
| | having an amine number of approx. 200 mg KOH/g, |
| | viscosity @ 25° C. of 900 mPa s, commercially |
| | available as DESMOPHEN NH 1420 from Covestro; |
| ASPARTATE B | a 100% solids content aspartic ester functional amine, |
| | having an amine number of approx. 191 mg KOH/g, |
| | viscosity @ 25° C. of 1400 mPa s, commercially |
| | available as DESMOPHEN NH 1520 from Covestro; |
| ADDITIVE A | a surface additive on polyacrylate-basis for solvent- |
| | borne coating systems and printing inks, |
| | commercially available as BYK-358N from BYK |
| | Chemie; |
| ADDITIVE B | a solution of a polymethylalkylsiloxane commercially |
| | available as BYK-077 from BYK Chemie; |
| ADDITIVE C | a proprietary amide-modified hydrogenated castor oil |
| | rheology modifier, commercially available as |
| | CRAYVALLAC SF from Arkema; |
| PIGMENT A | titanium dioxide pigment, commercially available as |
| | KRONOS 2310 from Kronos, Inc.; |
| SOLVENT A | n-butyl acetate; |
| ISOCYANATE A | an isocyanurate group-containing polyisocyanate |
| | prepared from 1,6-hexamethylene diisocyanate and |
| | having an isocyanate content of 21.6%, a content of |
| | monomeric diisocyanate of <0.2% and a viscosity of |
| | 3000 mPa s at 20° C., commercially available as |
| | DESMODUR N-3300A from Covestro; |
| DISPERSANT A | a solution of a salt of unsaturated polyamine amides |
| | and low-molecular acidic polyesters, commercially |
| | available from as ANTI-TERRA-U from BYK USA; |
| DISPERSANT B | a salt of unsaturated polyamine amides and low- |
| | molecular acidic polyesters, commercially available |
| | as ANTI-TERRA-U100 from BYK USA; |
| DISPERSANT C | a solution of a low molecular weight, unsaturated |
| | polycarboxylic acid polymer, commercially available |
| | as BYK-P104 from BYK USA; |
| DISPERSANT D | a low molecular weight, unsaturated polycarboxylic |
| | acid polymer, commercially available as BYK-P105 |
| | from BYK USA; |
| DISPERSANT E | a solution of copolymer with acidic groups, |
| | commercially available as DISPERBYK-110 from |
| | BYK; |
| DISPERSANT F | a solvent-free wetting and dispersing copolymer with |
| | acidic groups commercially available as |
| | DISPERBYK-111 from BYK Chemie; |
| DISPERSANT G | a high molecular weight wetting and dispersing |
| | additive for solvent-borne systems and pigment |
| | concentrates, commercially available as |
| | DISPERBYK-163 from BYK; |
| DISPERSANT H | a high molecular weight alkylolammonium salt of a |
| | copolymer with acidic groups for solvent-borne and |
| | water-borne systems, commercially available as |
| | DISPERBYK-180 from BYK; |
| DISPERSANT I | a block copolymer with basic, pigment-affinic |
| | groups, commercially available as DISPERBYK- |
| | 2155 from BYK; |
| DISPERSANT J | a polycarboxylic acid polymer, commercially |
| | available as LACTIMON from BYK; |
| DISPERSANT K | a high molecular weight alkylolamino amide, |
| | commercially available as DISPERBYK-109 from |
| | BYK; |
| DISPERSANT L | a solution of a structured acrylate copolymer with |
| | pigment-affinic groups, commercially available as |
| | DISPERBYK-2000 from BYK; and |
| DISPERSANT M | a solution of a high molecular weight block |
| | copolymer with pigment-affinic groups, |
| | commercially available as DISPERBYK-2163 from |
| | BYK. |

A standard paint formulation as summarized in Table I was made by combining ASPARTATE A, ASPARTATE B, ADDITIVES A, B, and C, PIGMENT A, and in the presence of SOLVENT A to form Component 1 which was reacted with ISOCYANATE A as Component 2 to form COMPOSITION A. One of DISPERSANTS A through M was added to COMPOSITION A to produce the FORMULATIONS as detailed in Table I.

TABLE I

| Formulation A | | | Formulation B | | | Formulation C | | |
|---|---|---|---|---|---|---|---|---|
| Wt. | Vol. | Wt. | Wt. | Vol. | Wt. | Wt. | Vol. | Wt. |
| (lbs.) | (gal.) | Solids | (lbs.) | (gal.) | Solids | (lbs.) | (gal.) | Solids |

Component 1

| | | | | | | | | | |
|---|---|---|---|---|---|---|---|---|---|
| ASPARTATE A | 30.96 | 3.51 | 30.96 | 30.96 | 3.51 | 30.96 | 30.96 | 3.51 | 30.96 |
| ASPARTATE B | 13.14 | 1.49 | 13.14 | 13.14 | 1.49 | 13.14 | 13.14 | 1.49 | 13.14 |
| ADDITIVE A | 0.68 | 0.09 | 0.35 | 0.68 | 0.09 | 0.35 | 0.68 | 0.09 | 0.35 |
| ADDITIVE B | 0.68 | 0.09 | 0.35 | 0.68 | 0.09 | 0.35 | 0.68 | 0.09 | 0.35 |
| ADDITIVE C | 3 | 0.35 | 3 | 3 | 0.35 | 3 | 3 | 0.35 | 3 |
| PIGMENT A | 92.22 | 2.77 | 92.22 | 92.22 | 2.77 | 92.22 | 92.22 | 2.77 | 92.22 |
| SOLVENT A | 26.98 | 3.67 | 0 | 27.32 | 3.71 | 0 | 26.69 | 3.63 | 0 |
| DISPERSANT A | 0.69 | 0.09 | 0.35 | | | | | | |
| DISPERSANT B | | | | 0.32 | 0.04 | 0.32 | | | |
| DISPERSANT C | | | | | | | 1.38 | 0.18 | 0.69 |
| DISPERSANT D | | | | | | | | | |
| DISPERSANT E | | | | | | | | | |
| DISPERSANT F | | | | | | | | | |
| DISPERSANT G | | | | | | | | | |
| DISPERSANT H | | | | | | | | | |
| DISPERSANT I | | | | | | | | | |
| DISPERSANT J | | | | | | | | | |
| DISPERSANT K | | | | | | | | | |
| DISPERSANT L | | | | | | | | | |
| DISPERSANT M | | | | | | | | | |
| Subtotal | 168.35 | 12.05 | 140.37 | 168.32 | 12.05 | 140.35 | 168.76 | 12.1 | 140.72 |

Component 2

| | | | | | | | | | |
|---|---|---|---|---|---|---|---|---|---|
| ISOCYANATE A | 31.49 | 3.25 | 31.49 | 31.49 | 3.25 | 31.49 | 31.49 | 3.25 | 31.49 |
| Subtotal | 31.49 | 3.25 | 31.49 | 31.49 | 3.25 | 31.49 | 31.49 | 3.25 | 31.49 |
| Total | 199.84 | 15.3 | 171.86 | 199.81 | 15.3 | 171.84 | 200.25 | 15.35 | 172.21 |

Theoretical Results

| Weight Solids (%) | 86 | | | 86 | | | 86 | | |
|---|---|---|---|---|---|---|---|---|---|
| Wt./Gal (lbs./gal) | 13.06 | | | 13.06 | | | 13.04 | | |
| Volume Solids (%) | 75.22 | | | 75.23 | | | 75.24 | | |
| Mix Ratio (volume) | 3.70:1 | | | 3.70:1 | | | 3.72:1 | | |
| P/B | 1.22 | | | 1.22 | | | 1.22 | | |
| NCO:OH | 1.05 | | | 1.05 | | | 1.05 | | |
| PVC | 25.08 | | | 25.08 | | | 25.08 | | |
| Theoretical VOC | 1.83 | | | 1.83 | | | 1.83 | | |
| (lbs./gal) | | | | | | | | | |
| | Formulation D | | | Formulation E | | | Formulation F | | |
| | Wt. | Vol. | Wt. | Wt. | Vol. | Wt. | Wt. | Vol. | Wt. |
| | (lbs.) | (gal.) | Solids | (lbs.) | (gal.) | Solids | (lbs.) | (gal.) | Solids |

Component 1

| | | | | | | | | | |
|---|---|---|---|---|---|---|---|---|---|
| ASPARTATE A | 30.96 | 3.51 | 30.96 | 30.96 | 3.51 | 30.96 | 30.96 | 3.51 | 30.96 |
| ASPARTATE B | 13.14 | 1.49 | 13.14 | 13.14 | 1.49 | 13.14 | 13.14 | 1.49 | 13.14 |
| ADDITIVE A | 0.68 | 0.09 | 0.35 | 0.68 | 0.09 | 0.36 | 0.69 | 0.09 | 0.36 |
| ADDITIVE B | 0.68 | 0.09 | 0.35 | 0.68 | 0.09 | 0.36 | 0.69 | 0.09 | 0.36 |
| ADDITIVE C | 3.01 | 0.35 | 3.01 | 3.02 | 0.35 | 3.02 | 3.04 | 0.36 | 3.04 |
| PIGMENT A | 92.22 | 2.77 | 92.22 | 92.22 | 2.77 | 92.22 | 92.22 | 2.77 | 92.22 |
| SOLVENT A | 27.42 | 3.73 | 0 | 26.17 | 3.56 | 0 | 27.72 | 3.77 | 0 |
| DISPERSANT A | | | | | | | | | |
| DISPERSANT B | | | | | | | | | |
| DISPERSANT C | | | | | | | | | |
| DISPERSANT D | 0.92 | 0.11 | 0.92 | | | | | | |
| DISPERSANT E | | | | 2.77 | 0.32 | 1.44 | | | |
| DISPERSANT F | | | | | | | 2.77 | 0.29 | 2.77 |
| DISPERSANT G | | | | | | | | | |
| DISPERSANT H | | | | | | | | | |
| DISPERSANT I | | | | | | | | | |
| DISPERSANT J | | | | | | | | | |
| DISPERSANT K | | | | | | | | | |
| DISPERSANT L | | | | | | | | | |
| DISPERSANT M | | | | | | | | | |
| Subtotal | 169.03 | 12.13 | 140.96 | 169.65 | 12.18 | 141.49 | 171.22 | 12.36 | 142.84 |

Component 2

| | | | | | | | | | |
|---|---|---|---|---|---|---|---|---|---|
| ISOCYANATE A | 31.49 | 3.25 | 31.49 | 31.49 | 3.25 | 31.49 | 31.49 | 3.25 | 31.49 |
| Subtotal | 31.49 | 3.25 | 31.49 | 31.49 | 3.25 | 31.49 | 31.49 | 3.25 | 31.49 |
| Total | 200.52 | 15.38 | 172.45 | 201.14 | 15.43 | 172.98 | 202.71 | 15.61 | 174.33 |

Theoretical Results

| Weight Solids (%) | 86 | | | 86 | | | 86 | | |
|---|---|---|---|---|---|---|---|---|---|
| Wt./Gal (lbs./gal) | 13.04 | | | 13.03 | | | 12.99 | | |
| Volume Solids (%) | 75.27 | | | 75.33 | | | 75.37 | | |
| Mix Ratio (volume) | 3.73:1 | | | 3.74:1 | | | 3.80:1 | | |
| P/B | 1.22 | | | 1.22 | | | 1.22 | | |
| NCO:OH | 1.05 | | | 1.05 | | | 1.05 | | |
| PVC | 25.08 | | | 25.08 | | | 25.08 | | |
| Theoretical VOC | 1.83 | | | 1.82 | | | 1.82 | | |
| (lbs./gal) | | | | | | | | | |
| | Formulation G | | | Formulation H | | | Formulation I | | |
| | Wt. | Vol. | Wt. | Wt. | Vol. | Wt. | Wt. | Vol. | Wt. |
| | (lbs.) | (gal.) | Solids | (lbs.) | (gal.) | Solids | (lbs.) | (gal.) | Solids |

Component 1

| | | | | | | | | | |
|---|---|---|---|---|---|---|---|---|---|
| ASPARTATE A | 30.96 | 3.51 | 30.96 | 30.96 | 3.51 | 30.96 | 30.96 | 3.51 | 30.96 |
| ASPARTATE B | 13.14 | 1.49 | 13.14 | 13.14 | 1.49 | 13.14 | 13.14 | 1.49 | 13.14 |
| ADDITIVE A | 0.69 | 0.09 | 0.36 | 0.69 | 0.09 | 0.36 | 0.69 | 0.09 | 0.36 |
| ADDITIVE B | 0.69 | 0.09 | 0.36 | 0.69 | 0.09 | 0.36 | 0.69 | 0.09 | 0.36 |
| ADDITIVE C | 3.02 | 0.36 | 3.02 | 3.02 | 0.36 | 3.02 | 3.02 | 0.36 | 3.02 |
| PIGMENT A | 92.22 | 2.77 | 92.22 | 92.22 | 2.77 | 92.22 | 92.22 | 2.77 | 92.22 |
| SOLVENT A | 25.29 | 3.44 | 0 | 27.57 | 3.75 | 0 | 27.57 | 3.75 | 0 |
| DISPERSANT A | | | | | | | | | |
| DISPERSANT B | | | | | | | | | |
| DISPERSANT C | | | | | | | | | |
| DISPERSANT D | | | | | | | | | |
| DISPERSANT E | | | | | | | | | |
| DISPERSANT F | | | | | | | | | |
| DISPERSANT G | 4.15 | 0.5 | 1.87 | | | | | | |
| DISPERSANT H | | | | 1.84 | 0.21 | 1.84 | | | |
| DISPERSANT I | | | | | | | 1.84 | 0.21 | 1.84 |
| DISPERSANT J | | | | | | | | | |
| DISPERSANT K | | | | | | | | | |
| DISPERSANT L | | | | | | | | | |
| DISPERSANT M | | | | | | | | | |
| Subtotal | 170.16 | 12.23 | 141.93 | 170.13 | 12.25 | 141.9 | 170.13 | 12.25 | 141.9 |

Component 2

| | | | | | | | | | |
|---|---|---|---|---|---|---|---|---|---|
| ISOCYANATE A | 31.49 | 3.25 | 31.49 | 31.49 | 3.25 | 31.49 | 31.49 | 3.25 | 31.49 |
| Subtotal | 31.49 | 3.25 | 31.49 | 31.49 | 3.25 | 31.49 | 31.49 | 3.25 | 31.49 |
| Total | 201.65 | 15.49 | 173.42 | 201.62 | 15.51 | 173.39 | 201.62 | 15.51 | 173.39 |

Theoretical Results

| Weight Solids (%) | 86 | | | 86 | | | 86 | | |
|---|---|---|---|---|---|---|---|---|---|
| Wt./Gal (lbs./gal) | 13.02 | | | 13 | | | 13 | | |
| Volume Solids (%) | 75.32 | | | 75.34 | | | 75.34 | | |
| Mix Ratio (volume) | 3.76:1 | | | 3.77:1 | | | 3.77:1 | | |
| P/B | 1.22 | | | 1.22 | | | 1.22 | | |
| NCO:OH | 1.05 | | | 1.05 | | | 1.05 | | |
| PVC | 25.08 | | | 25.08 | | | 25.08 | | |
| Theoretical VOC | 1.82 | | | 1.82 | | | 1.82 | | |
| (lbs./gal) | | | | | | | | | |
| | Formulation J | | | Formulation K | | | Formulation L | | |
| | Wt. | Vol. | Wt. | Wt. | Vol. | Wt. | Wt. | Vol. | Wt. |
| | (lbs.) | (gal.) | Solids | (lbs.) | (gal.) | Solids | (lbs.) | (gal.) | Solids |

Component 1

| | | | | | | | | | |
|---|---|---|---|---|---|---|---|---|---|
| ASPARTATE A | 30.96 | 3.51 | 30.96 | 30.96 | 3.51 | 30.96 | 30.96 | 3.51 | 30.96 |
| ASPARTATE B | 13.14 | 1.49 | 13.14 | 13.14 | 1.49 | 13.14 | 13.14 | 1.49 | 13.14 |
| ADDITIVE A | 0.68 | 0.09 | 0.35 | 0.68 | 0.09 | 0.36 | 0.69 | 0.09 | 0.36 |
| ADDITIVE B | 0.68 | 0.09 | 0.35 | 0.68 | 0.09 | 0.36 | 0.69 | 0.09 | 0.36 |
| ADDITIVE C | 3 | 0.35 | 3 | 3.02 | 0.35 | 3.02 | 3.02 | 0.36 | 3.02 |
| PIGMENT A | 92.22 | 2.77 | 92.22 | 92.22 | 2.77 | 92.22 | 92.22 | 2.77 | 92.22 |
| SOLVENT A | 26.69 | 3.63 | 0 | 27.49 | 3.74 | 0 | 24.8 | 3.37 | 0 |
| DISPERSANT A | | | | | | | | | |
| DISPERSANT B | | | | | | | | | |
| DISPERSANT C | | | | | | | | | |
| DISPERSANT D | | | | | | | | | |
| DISPERSANT E | | | | | | | | | |
| DISPERSANT F | | | | | | | | | |
| DISPERSANT G | | | | | | | | | |
| DISPERSANT H | | | | | | | | | |
| DISPERSANT I | | | | | | | | | |
| DISPERSANT J | 1.38 | 0.18 | 0.69 | | | | | | |
| DISPERSANT K | | | | 1.38 | 0.18 | 1.38 | | | |
| DISPERSANT L | | | | | | | 4.61 | 0.59 | 1.84 |
| DISPERSANT M | | | | | | | | | |
| Subtotal | 168.76 | 12.1 | 140.72 | 169.58 | 12.21 | 141.43 | 170.13 | 12.26 | 141.9 |

Component 2

| | | | | | | | | | |
|---|---|---|---|---|---|---|---|---|---|
| ISOCYANATE A | 31.49 | 3.25 | 31.49 | 31.49 | 3.25 | 31.49 | 31.49 | 3.25 | 31.49 |
| Subtotal | 31.49 | 3.25 | 31.49 | 31.49 | 3.25 | 31.49 | 31.49 | 3.25 | 31.49 |
| Total | 200.25 | 15.36 | 172.21 | 201.07 | 15.46 | 172.92 | 201.62 | 15.51 | 173.39 |

Theoretical Results

| Weight Solids (%) | 86 | 86 | 86 |
|---|---|---|---|
| Wt./Gal (lbs./gal) | 13.04 | 13 | 13 |
| Volume Solids (%) | 75.25 | 75.34 | 75.64 |
| Mix Ratio (volume) | 3.72:1 | 3.75:1 | 3.77:1 |
| P/B | 1.22 | 1.22 | 1.22 |
| NCO:OH | 1.05 | 1.05 | 1.05 |
| PVC | 25.08 | 25.08 | 25.08 |
| Theoretical VOC | 1.83 | 1.82 | 1.82 |
| (lbs./gal) | | | |

| Formulation M | | |
|---|---|---|
| Wt. | Vol. | Wt. |
| (lbs.) | (gal.) | Solids |

Component 1

| | | | |
|---|---|---|---|
| ASPARTATE A | 30.96 | 3.51 | 30.96 |
| ASPARTATE B | 13.14 | 1.49 | 13.14 |
| ADDITIVE A | 0.69 | 0.09 | 0.36 |
| ADDITIVE B | 0.69 | 0.09 | 0.36 |
| ADDITIVE C | 3.02 | 0.36 | 3.02 |
| PIGMENT A | 92.22 | 2.77 | 92.22 |
| SOLVENT A | 25.29 | 3.44 | 0 |
| DISPERSANT A | | | |
| DISPERSANT B | | | |
| DISPERSANT C | | | |
| DISPERSANT D | | | |
| DISPERSANT E | | | |
| DISPERSANT F | | | |
| DISPERSANT G | | | |
| DISPERSANT H | | | |
| DISPERSANT I | | | |
| DISPERSANT J | | | |
| DISPERSANT K | | | |
| DISPERSANT L | | | |
| DISPERSANT M | 4.15 | 0.53 | 1.87 |
| Subtotal | 170.16 | 12.27 | 141.93 |

Component 2

| | | | |
|---|---|---|---|
| ISOCYANATE A | 31.49 | 3.25 | 31.49 |
| Subtotal | 31.49 | 3.25 | 31.49 |
| Total | 201.65 | 15.52 | 173.42 |

Theoretical Results

| Weight Solids (%) | 86 |
|---|---|
| Wt./Gal (lbs./gal) | 12.99 |
| Volume Solids (%) | 75.42 |
| Mix Ratio (volume) | 3.77:1 |
| P/B | 1.22 |
| NCO:OH | 1.05 |
| PVC | 25.08 |
| Theoretical VOC | 1.82 |
| (lbs./gal) | |

DISPERSANTS A through M were added to new samples of COMPOSITION A as detailed in Table II and the initial 60° gloss of the formulation was measured for samples in two separate climate control chambers: a constant temperature room (CTR) and a THERMOTRON environmental test chamber (commercially available from Thermotron Industries, Holland, Mich., USA).

TABLE II

| | | Dispersant | | | |
|---|---|---|---|---|---|
| | | amount over | | | |
| | Dispersant | pigment | Acid Value | 60° gloss | 60° gloss in |
| Dispersant | Type | solids | (mgKOH/g) | in CTR | THERMOTRON |
| A | fatty acid | 0.75% | 24 | 68 | 61.95 |
| B | fatty acid | 0.35% | 50 | 61.2 | 48.5 |
| C | fatty acid | 1.50% | 180 | 73.95 | 74.45 |
| D | fatty acid | 1.00% | 365 | 75.1 | 80.85 |
| E | phosphoric | 3.00% | 53 | 89.85 | 87.55 |
| | acid ester | | | | |
| F | phosphoric | 3.00% | 129 | 91.85 | 90.55 |
| | acid ester | | | | |
| G | polyurethane | 4.50% | — | 92.3 | 83.05 |
| H | phosphoric | 2.00% | 94 | 90.2 | 84.85 |
| | acid ester | | | | |
| I | polyurethane | 2.00% | — | 87.75 | 83.65 |
| J | fatty acid | 1.50% | 60 | 65.25 | 57.3 |
| K | fatty acid | 1.50% | — | 71.5 | 78.65 |
| L | polyurethane | 5.00% | — | 92.45 | 79.8 |
| M | acrylate | 4.50% | — | 90.05 | 84.2 |
| | copolymer | | | | |

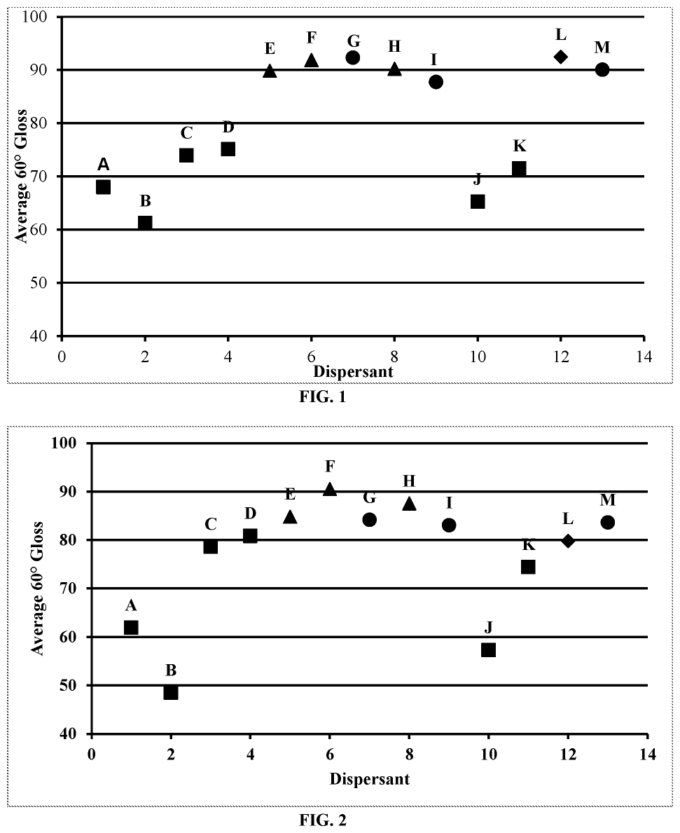

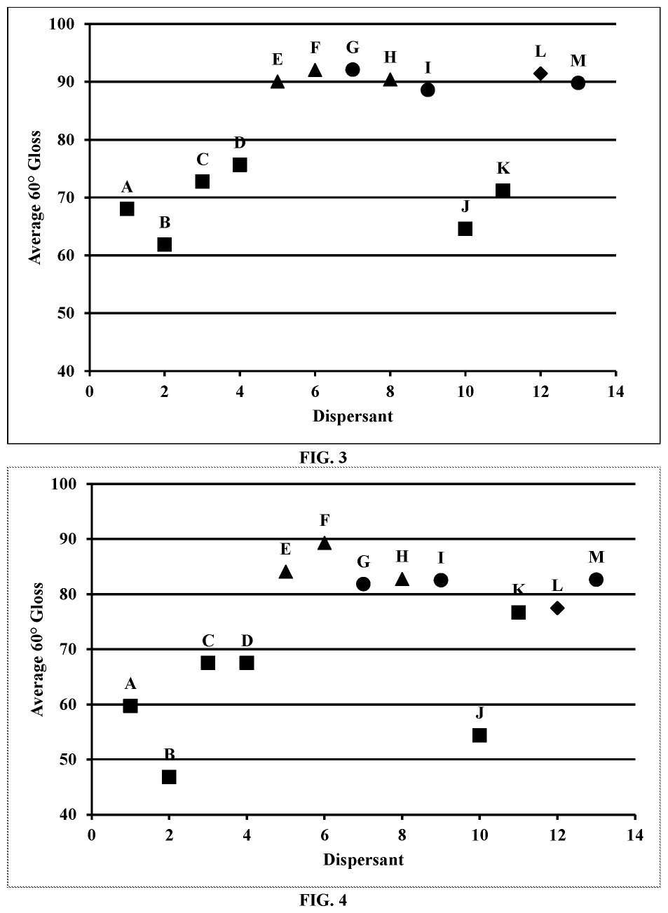

As shown in FIG. 1, FIG. 2, FIG. 3, and FIG. 4, DISPERSANTS A, B, C, D, J, and K (fatty acid dispersants), are designated with squares. DISPERSANTS E, F, and H (phosphoric acid ester dispersants), are designated with triangles. DISPERSANTS G, I, and M (polyurethane dispersants), are designated with circles. DISPERSANT L (acrylate copolymer dispersant), is designated with a diamond.

FIG. 1 shows the initial 60° gloss measurements for COMPOSITION A samples containing the various dispersants in the constant temperature room (CTR) at 21.1° C. and 50% relative humidity. FIG. 2 illustrates the initial 60° gloss measurements for COMPOSITION A samples containing the various dispersants in the THERMOTRON environmental test chamber at 40° C. and 80% relative humidity. FIG. 3 shows the four week 60° gloss measurements for COMPOSITION A samples containing the various dispersants in the CTR at 21.1° C. and 50% relative humidity. FIG. 4 illustrates the four week 60° gloss measurements for COMPOSITION A samples containing the various dispersants in the THERMOTRON environmental test chamber at 40° C. and 80% relative humidity.

As can be appreciated by reference to FIGS. 1-4, those COMPOSITION A samples containing the polyaspartic composition containing phosphoric acid ester dispersants (DISPERSANTS E, F, and H) performed better than COMPOSITION A samples containing the other dispersants in producing samples with a high initial 60° gloss and in maintaining that high 60° gloss.

The formation of hydantoin was monitored by FTIR-ATR spectroscopy using a THERMO NICOLET NEXUS 670 FT-IR spectrometer with a diamond ATR accessory. The absorbance at ˜1768 cm⁻¹ was recorded at each sampling. A single-point baseline at ˜1899 cm⁻¹ was incorporated to obtain peak height.

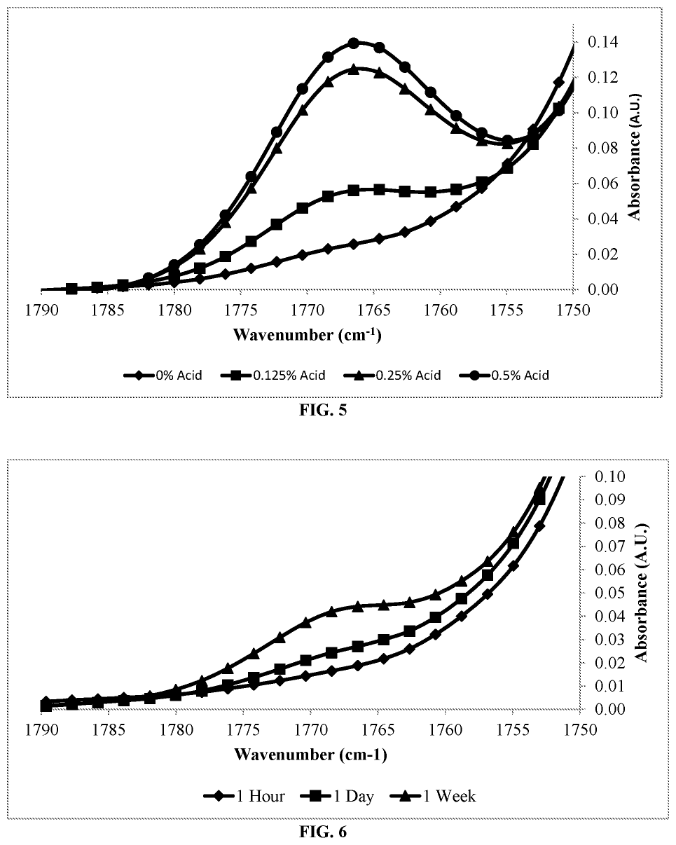

FIG. 5 shows the IR spectra (absorbance vs. wavenumber) at one day with no acid added, at one day with 0.125% acid added, at one day with 0.25% acid added, and at one day with 0.5% acid added, to illustrate hydantoin formation.

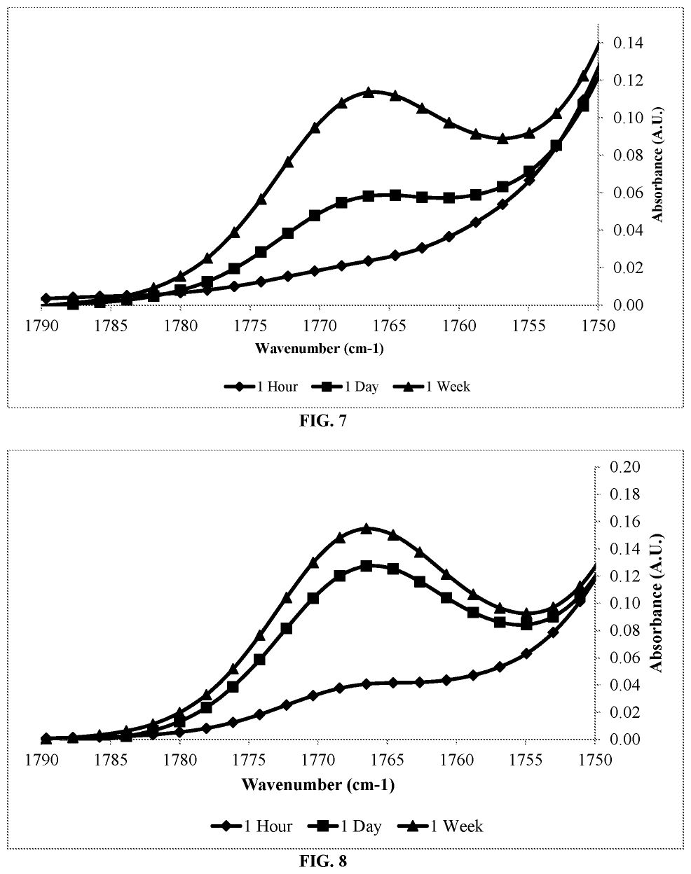

FIGS. 6, 7, and 8 compare the IR spectra (absorbance vs. wavenumber) of hydantoin formation was measured at one hour, at one week, and at one day for coatings with no acid, with 0.125% acid, and with 0.25% acid, added respectively.

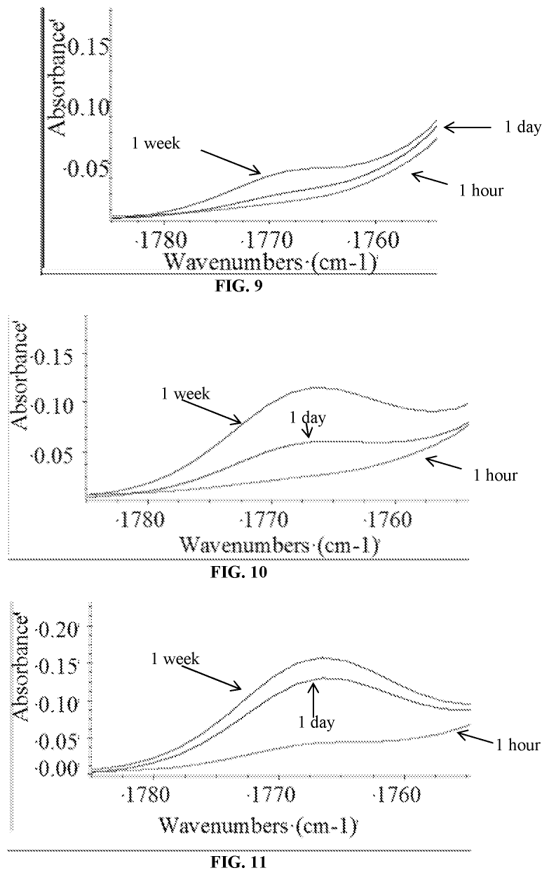

Table III along with FIGS. 9, 10, and 11 provide the results of an acid ladder study examining the relationship between an increase in hydantoin formation and a decrease in gloss over time. The bottom line in each of FIG. 9 (0% acid), FIG. 10 (0.125% acid), and FIG. 11 (0.25% acid) was measured at one hour, the middle line was measured at one day and the upper line was measured at one week. As those skilled in the art will appreciate by reference to Table III and FIGS. 9, 10, and 11, the 60° gloss loss of the inventive coatings correlates with the absorbance increase in the IR spectra (absorbance vs. wavenumber) such that, as more acid was added to the inventive coating, more hydantoin formation occurred, which in turn resulted in larger amounts of 60° gloss loss.

TABLE III

| | 0% Acid | | | 0.125% Acid | | | 0.25% Acid | | |
|---|---|---|---|---|---|---|---|---|---|
| | | 60° Gloss | Absorbance | | 60° Gloss | Absorbance | | 60° Gloss | Absorbance |
| Time | 60° Gloss | % Decrease | % Increase | 60° Gloss | % Decrease | % Increase | 60° Gloss | % Decrease | % Increase |
| 1 hour | 84.7 | — | — | 90.9 | — | — | 83.9 | — | — |
| 1 day | 84.2 | 0.6% | 44% | 88.3 | 2.9% | 136% | 69.6 | 17.0% | 191% |
| 1 week | 82.3 | 2.3% | 69% | 85.5 | 3.2% | 98% | 68.7 | 1.3% | 20% |

TABLE IV

| Acid | Initial | 60° Gloss | Absorbance |
|---|---|---|---|
| Amount | 60° Gloss | Loss | (A.U.) |
| 0% | 84.7 | 0.5 | 0.028 |
| 0.125% | 90.9 | 2.6 | 0.057 |
| 0.25% | 83.9 | 14.3 | 0.124 |
| 0.5% | 81.8 | 13.8 | 0.143 |
| 1% | 81.2 | 6.8 | 0.158 |
| 2% | 3.5 | −0.1 | 0.187 |

As shown in Table IV, at one day, this effect was maximized by the addition of 0.25% acid. The samples at 1% and 2% produced an exotherm.

The four-week 60° gloss was also measured for the samples. Without wishing to be bound by any theory, the present inventors speculate that the 60° gloss loss is catalyzed by acid functionalities. Thus, it is counterintuitive to add an acid functional dispersant to obtain a high initial 60° gloss.

This specification has been written with reference to various non-limiting and non-exhaustive embodiments. However, it will be recognized by persons having ordinary skill in the art that various substitutions, modifications, or combinations of any of the disclosed embodiments (or portions thereof) may be made within the scope of this specification. Thus, it is contemplated and understood that this specification supports additional embodiments not expressly set forth herein. Such embodiments may be obtained, for example, by combining, modifying, or reorganizing any of the disclosed steps, components, elements, features, aspects, characteristics, limitations, and the like, of the various non-limiting embodiments described in this specification. In this manner, Applicant reserves the right to amend the claims during prosecution to add features as variously described in this specification, and such amendments comply with the requirements of 35 U.S.C. § 112(a), and 35 U.S.C. § 132(a).

Various aspects of the subject matter described herein are set out in the following numbered clauses:

Clause 1. A polyaspartic composition comprising a reaction product of a polyamine with a Michael addition receptor, a pigment, and from >0% to ≤3% of a phosphoric acid ester dispersant, wherein the percentage is calculated as (weight of dispersant solids/weight of pigment solids)×100.

Clause 2. The polyaspartic composition according to Clause 1, wherein the polyamine is selected from the group consisting of ethylenediamine, 1,2-diaminopropane, 1,4-diaminobutane, 1,6-diaminohexane, 2,5-diamino-2,5-dimethylhexane, 2,2,4-trimethyl-1,6-diaminohexane, 2,4,4-trimethyl-1,6-diaminohexane, 1,11-diaminoundecane, 1,12-diaminododecane, 1-amino-3,3,5-trimethyl-5-aminomethylcyclohexane, 2,4-hexahydrotoluylenediamine, 2,6-hexahydrotoluylenediamine, 2,4′-diaminodicyclohexylmethane, 4,4′-diaminodicyclohexylmethane, 3,3′-dimethyl-4,4′-diaminodicyclohexylmethane, and 2,4,4′-triamino-5-methyldicyclohexylmethane.

Clause 3. The polyaspartic composition according to one of Clauses 1 and 2, wherein the Michael addition receptor is selected from the group consisting of dimethyl maleate, diethyl maleate, dibutyl maleate, dimethyl fumarate, diethyl fumarate, dibutyl fumarate, acrylates, and combinations thereof.

Clause 4. The polyaspartic composition according to any one of Clauses 1 to 3, wherein the phosphoric acid ester dispersant is of the formula

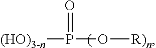

wherein R is an aliphatic, cycloaliphatic and/or aromatic moiety free of Zerewitinoff hydrogen, containing at least one ether oxygen atom (—O—) and at least one carboxylic acid ester group (—COO—) and/or urethane group (—NHCOO—), and having an average molecular weight M of 200 to 10,000, in which the hydrogen atoms of the aliphatic groups may be partially replaced by halogen atoms, and wherein the ratio of the number of ether oxygen atoms to the number of the carboxylic acid ester groups and/or urethane groups in each group R is in the range from 1:20 to 20:1, and n is 1 or 2.

Clause 5. The polyaspartic composition according to any one of Clauses 1 to 4, wherein the phosphoric acid ester dispersant is included in amounts of 0.125% to 2%, wherein the percentage is calculated as (weight of dispersant solids/weight of pigment solids)×100.

Clause 6. The polyaspartic composition according to any one of Clauses 1 to 5, wherein the phosphoric acid ester dispersant is included in amounts of 0.75% to 1.5%, wherein the percentage is calculated as (weight of dispersant solids/weight of pigment solids)×100.

Clause 7. The polyaspartic composition according to any one of Clauses 1 to 6, wherein the phosphoric acid ester dispersant is included in amounts of 1.0% to 1.5%, wherein the percentage is calculated as (weight of dispersant solids/weight of pigment solids)×100.

Clause 8. The polyaspartic composition according to any one of Clauses 1 to 7, wherein the pigment is selected from the group consisting of a black pigment, a blue pigment, a brown pigment, a cyan pigment, a gold pigment, a green pigment, a grey pigment, a magenta pigment, an orange pigment, a pink pigment, a red pigment, a violet pigment, a white pigment, a yellow pigment, or a combination thereof.

Clause 9. A polyurea or polyurethane composition comprising a reaction product of a polyisocyanate and the polyaspartic composition according to any one of Clauses 1 to 8.

Clause 10. The polyurea or polyurethane composition according to Clause 9, wherein the polyisocyanate is selected from the group consisting of ethylene diisocyanate, 1,4-tetramethylene diisocyanate, 1,6-hexamethylene diisocyanate (HDI), 2,2,4- and/or 2,4,4-trimethyl-hexamethylene diisocyanate, 1,5-pentamethylene diisocyanate (PDI), 1,12-dodecamethylene diisocyanate, 5-isocyanato-1-(isocyanatomethyl)-1,3,3-trimethylcyclohexane (IPDI), bis-(4-isocyanatocyclohexyl)methane (H₁₂MDI); cyclohexane 1,4-diisocyanate, bis-(4-isocyanato-3-methyl-cyclohexyl)methane, 2,4- and/or 4,4′ diisocyanato-dicyclohexyl-methane, 1-isocyanato-1-methyl-3(4)-isocyanatomethyl-cyclohexane (IMCI), 1,4-cyclohexane diisocyanate (CHDI), benzene diisocyanate, toluene diisocyanate (TDI), diphenylmethane diisocyanate (MDI), and trimers, isocyanurates, uretdiones, biurets, allophanates, iminooxadiazine diones, carbodiimides, oxadiazine triones, and prepolymers of any of these, and mixtures thereof.

Clause 11. A coating composition comprising the polyurea or polyurethane composition according to one of Clauses 9 and 10.

Clause 12. A method of increasing 60° gloss in a cured polyurea or polyurethane composition, the method comprising reacting a polyisocyanate with the polyaspartic composition according to any one of Clauses 1 to 8 to form a reaction product; and curing the reaction product, wherein 60° gloss of the cured polyurea or polyurethane composition is ≥80%.

Clause 13. The method according to Clause 12, wherein the polyisocyanate and the polyaspartic composition are reacted at a temperature of from 21.1° C. to 40° C.

Clause 14. The method according to one of Clauses 12 and 13, wherein the polyisocyanate and the polyaspartic composition are reacted at a relative humidity of from 50% to 80%.

Clause 15. The method according to any one of Clauses 12 to 14, wherein the polyisocyanate is selected from the group consisting of ethylene diisocyanate, 1,4-tetramethylene diisocyanate, 1,6-hexamethylene diisocyanate (HDI), 2,2,4- and/or 2,4,4-trimethyl-hexamethylene diisocyanate, 1,5-pentamethylene diisocyanate (PDI), 1,12-dodecamethylene diisocyanate, 5-isocyanato-1-(isocyanatomethyl)-1,3,3-trimethylcyclohexane (IPDI), bis-(4-isocyanatocyclohexyl)methane (H₁₂MDI); cyclohexane 1,4-diisocyanate, bis-(4-isocyanato-3-methyl-cyclohexyl)methane, 2,4- and/or 4,4′ diisocyanato-dicyclohexyl-methane, 1-isocyanato-1-methyl-3(4)-isocyanatomethyl-cyclohexane (IMCI), 1,4-cyclohexane diisocyanate (CHDI), benzene diisocyanate, toluene diisocyanate (TDI), diphenylmethane diisocyanate (MDI), and trimers, isocyanurates, uretdiones, biurets, allophanates, iminooxadiazine diones, carbodiimides, oxadiazine triones, and prepolymers of any of these, and mixtures thereof.

Clause 16. The method according to any one of Clauses 12 to 15, wherein the 60° gloss is maintained over at least one-week at 40° C. and 80% relative humidity.

Clause 17. The method according to any one of Clauses 12 to 16, wherein the 60° gloss is maintained over at least four-weeks at 40° C. and 80% relative humidity.

What is claimed is:

1. A polyaspartic composition comprising a reaction product of:
a polyamine with a Michael addition receptor;
a pigment; and
from >0% to ≤3% of a phosphoric acid ester dispersant,
wherein the percentage is calculated as (weight of dispersant solids/weight of pigment solids)×100.

2. The polyaspartic composition according to claim 1, wherein the polyamine is selected from the group consisting of ethylenediamine, 1,2-diaminopropane, 1,4-diaminobutane, 1,6-diaminohexane, 2,5-diamino-2,5-dimethylhexane, 2,2,4-trimethyl-1,6-diaminohexane, 2,4,4-trimethyl-1,6-diaminohexane, 1,11-diaminoundecane, 1,12-diaminododecane, 1-amino-3,3,5-trimethyl-5-aminomethylcyclohexane, 2,4-hexahydrotoluylenediamine, 2,6-hexahydrotoluylenediamine, 2,4′-diaminodicyclohexylmethane, 4,4′-diaminodicyclohexylmethane, 3,3′-dimethyl-4,4′-diaminodicyclohexylmethane, and 2,4,4′-triamino-5-methyldicyclohexylmethane.

3. The polyaspartic composition according to claim 1, wherein the Michael addition receptor is selected from the group consisting of dimethyl maleate, diethyl maleate, dibutyl maleate, dimethyl fumarate, diethyl fumarate, dibutyl fumarate, acrylates, and combinations thereof.

4. The polyaspartic composition according to claim 1, wherein the phosphoric acid ester dispersant is of the formula 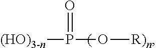
wherein R is an aliphatic, cycloaliphatic or aromatic moiety free of Zerewitinoff hydrogen, containing at least one ether oxygen atom (—O—) and at least one carboxylic acid ester group (—COO—) and/or urethane group (—NHCOO—), and having an average molecular weight M of 200 to 10,000, in which the hydrogen atoms of the aliphatic groups may be partially replaced by halogen atoms, and wherein the ratio of the number of ether oxygen atoms to the number of the carboxylic acid ester groups and/or urethane groups in each group R is from 1:20 to 20:1, and n is 1 or 2.

5. The polyaspartic composition according to claim 1, wherein the phosphoric acid ester dispersant is included in amounts of 0.125% to 2%, wherein the percentage is calculated as (weight of dispersant solids/weight of pigment solids)×100.

6. The polyaspartic composition according to claim 1, wherein the phosphoric acid ester dispersant is included in amounts of 0.75% to 1.5%, wherein the percentage is calculated as (weight of dispersant solids/weight of pigment solids)×100.

7. The polyaspartic composition according to claim 1, wherein the phosphoric acid ester dispersant is included in amounts of 1.0% to 1.5%, wherein the percentage is calculated as (weight of dispersant solids/weight of pigment solids)×100.

8. A polyurea or polyurethane composition comprising a reaction product of a polyisocyanate and the polyaspartic composition according to claim 1.

9. The polyurea or polyurethane composition according to claim 8, wherein the polyisocyanate is selected from the group consisting of ethylene diisocyanate, 1,4-tetramethylene diisocyanate, 1,6-hexamethylene diisocyanate, 2,2,4-trimethyl-hexamethylene diisocyanate, 2,4,4-trimethyl-hexamethylene diisocyanate, 1,5-pentamethylene diisocyanate, 1,12-dodecamethylene diisocyanate, 5-isocyanato-1-(isocyanatomethyl)-1,3,3-trimethylcyclohexane, bis-(4-isocyanatocyclohexyl)methane, cyclohexane 1,4-diisocyanate, bis-(4-isocyanato-3-methyl-cyclohexyl)methane, 2,4-diisocyanato-dicyclohexyl-methane, 4,4′ diisocyanato-dicyclohexyl-methane, 1-isocyanato-1-methyl-3(4)-isocyanatomethyl-cyclohexane, 1,4-cyclohexane diisocyanate, benzene diisocyanate, toluene diisocyanate, diphenylmethane diisocyanate, and trimers, isocyanurates, uretdiones, biurets, allophanates, iminooxadiazine diones, carbodiimides, oxadiazine triones, and prepolymers of any of these, and mixtures thereof.

10. A coating composition comprising the polyurea or polyurethane composition according to claim 8.

11. A method of increasing 60° gloss in a cured polyurea or polyurethane composition, the method comprising:
reacting a polyisocyanate with the polyaspartic composition according to claim 1 to form a reaction product; and
curing the reaction product.

12. The method according to claim 11, wherein the polyisocyanate and the polyaspartic composition are reacted at a temperature of from 21.1° C. to 40° C.

13. The method according to claim 11, wherein the polyisocyanate and the polyaspartic composition are reacted at a relative humidity of from 50% to 80%.

14. The method according to claim 11, wherein the polyisocyanate is selected from the group consisting of ethylene diisocyanate, 1,4-tetramethylene diisocyanate, 1,6-hexamethylene diisocyanate, 2,2,4-trimethyl-hexamethylene diisocyanate, 2,4,4-trimethyl-hexamethylene diisocyanate, 1,5-pentamethylene diisocyanate, 1,12-dodecamethylene diisocyanate, 5-isocyanato-1-(isocyanatomethyl)-1,3,3-trimethylcyclohexane, bis-(4-isocyanatocyclohexyl)methane, cyclohexane 1,4-diisocyanate, bis-(4-isocyanato-3-methyl-cyclohexyl)methane, 2,4-diisocyanato-dicyclohexyl-methane, 4,4′ diisocyanato-dicyclohexyl-methane, 1-isocyanato-1-methyl-3(4)-isocyanatomethyl-cyclohexane, 1,4-cyclohexane diisocyanate, benzene diisocyanate, toluene diisocyanate, diphenylmethane diisocyanate, and trimers, isocyanurates, uretdiones, biurets, allophanates, iminooxadiazine diones, carbodiimides, oxadiazine triones, and prepolymers of any of these, and mixtures thereof.

15. The method according to claim 11, wherein the 60° gloss is maintained over at least one-week at 40° C. and 80% relative humidity.

16. The method according to claim 11, wherein the 60° gloss is maintained over at least four-weeks at 40° C. and 80% relative humidity.
